(19) United States
(12) Patent Application Publication
(10) Pub. No.: US 2018/0198970 A1
(43) Pub. Date: Jul. 12, 2018

(54) HIGH DYNAMIC RANGE IMAGING USING CAMERA ARRAYS

(71) Applicant: INTEL CORPORATION, Santa Clara, CA (US)

(72) Inventors: Kalpana Seshadrinathan, Santa Clara, CA (US); Oscar Nestares, San Jose, CA (US)

(73) Assignee: INTEL CORPORATION, Santa Clara, CA (US)

(21) Appl. No.: 15/404,759

(22) Filed: Jan. 12, 2017

(51) Int. Cl. H04N 5/235; H04N 5/225; G06T 3/00; G06T 11/60; H04N 9/04; G06T 7/90; G06K 9/62

(52) U.S. Cl. CPC H04N 5/2355; H04N 5/2258; G06T 3/0093; G06T 11/60; H04N 9/045; G06T 2207/20208; H04N 5/2356; G06K 9/6202; G06T 2207/20221; G06T 2207/10024; G06T 2207/10004; G06T 7/90

(57) ABSTRACT

A system for high dynamic range (HDR) imaging for camera arrays is described herein. The system includes a camera array, a memory, and a processor. The memory is configured to store imaging data from the camera array. The processor is coupled to the memory and the camera array. The processor is to obtain a plurality of images and calculate a disparity estimation of a reference image of the plurality of images. The processor is also to warp a plurality of remaining images from the plurality of images to the reference image using the disparity estimation and merge the plurality of warped remaining images and the reference image to obtain a high dynamic range image.

### BACKGROUND ART

Camera arrays, which may be provided on computing devices such as tablets, smartphones, or in video surveillance systems, for example, can capture multiple images of the same scene, at the same time, from different angles. These images can then be processed to generate a three dimensional (3D) space or depth map, and accurately locate objects from the scene and into the 3D space. Processing the captured images may require an accurate determination of correspondences between positions and/or pixels within the respective captured images. In particular, the images may be processed to achieve high dynamic range images. High dynamic range (HDR) imaging reproduces a greater dynamic range of luminosity than is possible with standard digital imaging or photographic techniques.

### BRIEF DESCRIPTION OF THE DRAWINGS

FIG. 1 is a block diagram of an electronic device that enables high dynamic range imaging via camera arrays;

FIG. 2 is a plurality of images;

FIG. 3 is an illustration of a disparity map;

FIG. 4 is an illustration of images captured by a camera array and the resulting HDR image;

FIG. 5 is a process flow diagram of a method for HDR imaging; and

FIG. 6 is a block diagram showing media that contains logic for HDR imaging via a camera array.

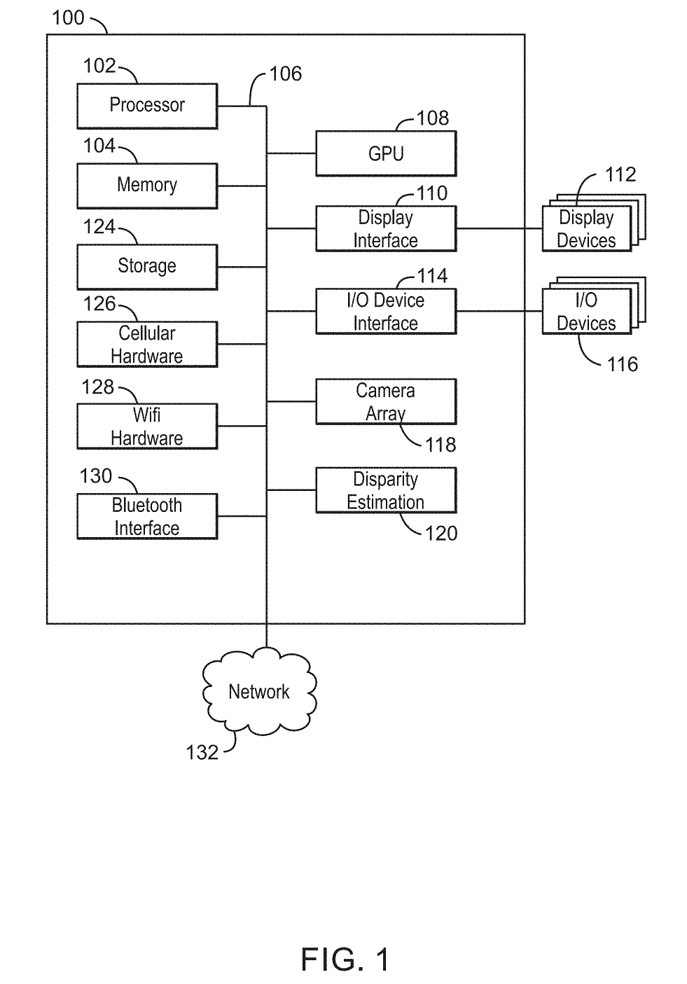

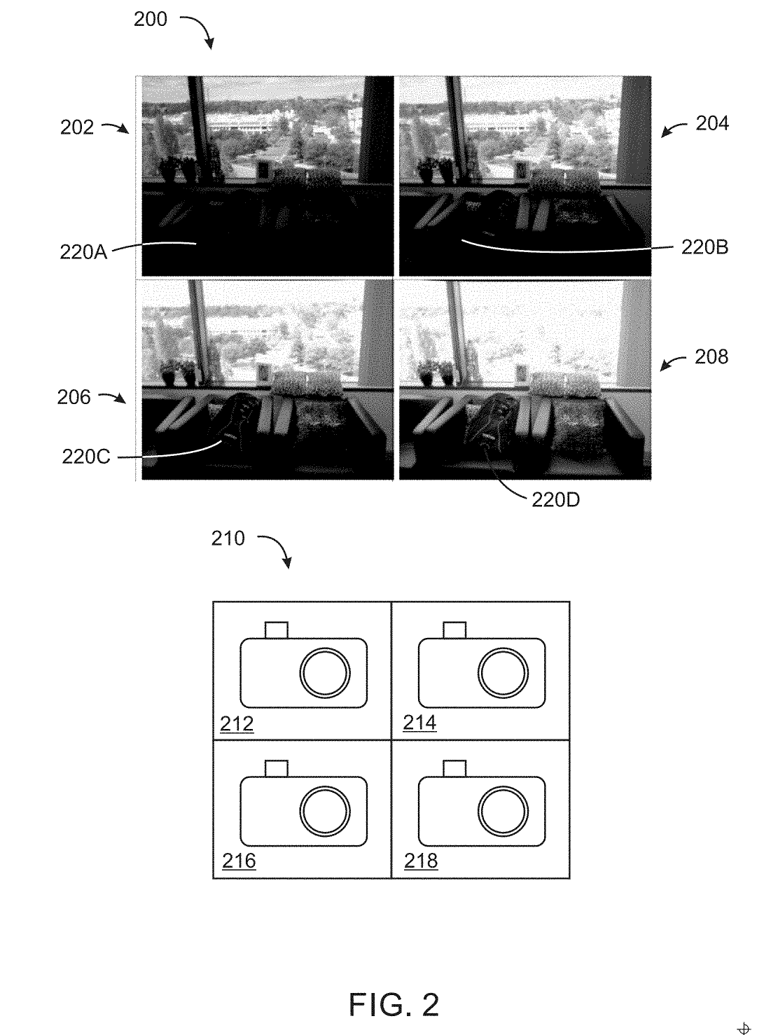

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The dynamic range that can be captured by a digital camera is fundamentally limited by the image sensor. The dynamic range of the real world (from bright sunlight to night time) and the range that can be perceived by a human observer often exceeds the dynamic range of a sensor used to capture a scene. HDR still image creation using multiple time sequential exposures is a common feature in most cameras and cell phones today. Often, HDR still image creation is achieved by spatially varying exposures on the sensor or interleaving frames with varying exposures.

Embodiments described herein enable high dynamic range imaging via camera arrays by setting different exposure times or gains to the different cameras and processing and combining the resulting videos. In embodiments, HDR video can be generated from small baseline synchronized camera arrays by assigning different exposures to each camera in the array. The multiple camera images may be aligned with varying exposure assignments while being computationally efficient. The aligned input videos are merged to create an output video with greater dynamic range than any one of the individual camera outputs. Such an approach has the advantage of a lack of motion across the different camera images due to the synchronized image capture. Additionally, the present techniques can recover artifact-free low dynamic range (LDR) video from any one of the cameras even in HDR mode.

Some embodiments may be implemented in one or a combination of hardware, firmware, and software. Further, some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device that enables high dynamic range imaging via camera arrays. The electronic device 100 may be, for example, a laptop computer, tablet computer, mobile phone, smart phone, or a wearable device, among others. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, or the like, to be displayed to a user of the electronic device 100. In some embodiments, the GPU 108 includes a number of graphics engines, wherein each graphics engine is configured to perform specific graphics tasks, or to execute specific types of workloads. For example, the GPU 108 may include an engine that processes video data.

The CPU 102 can be linked through the bus 106 to a display interface 110 configured to connect the electronic device 100 to a display device 112. The display device 112 can include a display screen that is a built-in component of the electronic device 100. The display device 112 can also include a computer monitor, television, or projector, among others, that is externally connected to the electronic device 100.

The CPU 102 can also be connected through the bus 106 to an input/output (I/O) device interface 114 configured to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100.

The electronic device 100 also includes a camera array 118 for capturing a plurality of images. In embodiments, the camera array may be a plurality of image capture mechanisms, sensors, or any combination thereof. Accordingly, the sensor may be a depth sensor, an image sensor such as a charge-coupled device (CCD) image sensor, a complementary metal-oxide-semiconductor (CMOS) image sensor, a system on chip (SOC) image sensor, an image sensor with photosensitive thin film transistors, or any combination thereof. The camera array 118 may capture the plurality of images using an array of cameras that are to each capture a scene at the same point in time. The camera array 118 can include any number of cameras or sensors. In some embodiments, the images from the camera array 118 can be used to generate a composite HDR image.

Generating the HDR image may involve combining some or all of the captured images of the plurality of images. Camera arrays can be used to generate HDR images and video by assigning different exposures or gains to different cameras of the camera array. In particular, HDR images and video may be generated from a synchronized camera array with varying exposure assignments. A disparity may be estimated for one of the images and is denoted as the reference image. Thus, a disparity estimation unit 120 may be used to determine the disparity or correspondences between positions and/or pixels within the respective captured images via an algorithm that can handle varying intensities and saturation. Based on such correspondences, depths may be estimated for objects and/or features associated with those positions and/or pixels.

All the images from the array are warped to the reference image using the estimated disparity map. The resulting images or videos are merged to create an output video that better represents the dynamic range of the scene than any one of the individual camera inputs. The camera response curve is not assumed or estimated, instead, a well exposed image or video is directly produced during the merging step. By producing the HDR image or video via merging, the present techniques lack calibration stages, have a better computational efficiency, and a better storage efficiency due to the lack of higher precision representations at any stage of computations.

The electronic device may also include a storage device 124. The storage device 124 is a physical memory such as a hard drive, an optical drive, a flash drive, an array of drives, or any combinations thereof. The storage device 124 can store user data, such as audio files, video files, audio/video files, and picture files, among others. The storage device 124 can also store programming code such as device drivers, software applications, operating systems, and the like. The programming code stored to the storage device 124 may be executed by the CPU 102, GPU 108, or any other processors that may be included in the electronic device 100.

The CPU 102 may be linked through the bus 106 to cellular hardware 126. The cellular hardware 126 may be any cellular technology, for example, the 4G standard (International Mobile Telecommunications-Advanced (IMT-Advanced) Standard promulgated by the International Telecommunications Union—Radio communication Sector (ITU-R)). In this manner, the electronic device 100 may access any network 132 without being tethered or paired to another device, where the network 132 is a cellular network.

The CPU 102 may also be linked through the bus 106 to WiFi hardware 128. The WiFi hardware is hardware according to WiFi standards (standards promulgated as Institute of Electrical and Electronics Engineers' (IEEE) 802.11 standards). The WiFi hardware 128 enables the electronic device 100 to connect to the Internet using the Transmission Control Protocol and the Internet Protocol (TCP/IP), where the network 132 is the Internet. Accordingly, the electronic device 100 can enable end-to-end connectivity with the Internet by addressing, routing, transmitting, and receiving data according to the TCP/IP protocol without the use of another device. Additionally, a Bluetooth Interface 130 may be coupled to the CPU 102 through the bus 106. The Bluetooth Interface 130 is an interface according to Bluetooth networks (based on the Bluetooth standard promulgated by the Bluetooth Special Interest Group). The Bluetooth Interface 130 enables the electronic device 100 to be paired with other Bluetooth enabled devices through a personal area network (PAN). Accordingly, the network 132 may be a PAN. Examples of Bluetooth enabled devices include a laptop computer, desktop computer, ultrabook, tablet computer, mobile device, or server, among others.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

In embodiments, intensity variations in captured images may occur due to varying exposures assigned to individual cameras for high dynamic range (HDR) imaging or may result from a heterogeneity of the sensors in the camera array. Thus, the cameras of an array may comprise heterogeneous sensors that capture images with varying intensities. Accurate disparity estimation in camera arrays is the first step in generating an HDR image or video. FIG. 2 is a plurality of images 200. The plurality of images 200 includes image 202, image 204, image 206, and image 208. The images may be captured by a camera array 210. The camera array 210 may include cameras 212, 214, 216, and 218. The camera 212 may capture image 202, the camera 214 may capture image 204, the camera 216 may capture image 206, and the camera 218 may capture image 208. In the example of HDR image capture, each of cameras 212, 214, 216, and 218 include varying exposure assignments and can also have varying imaging sensors. In embodiments, image exposure refers to the amount of light per unit area that reaches an image sensor.

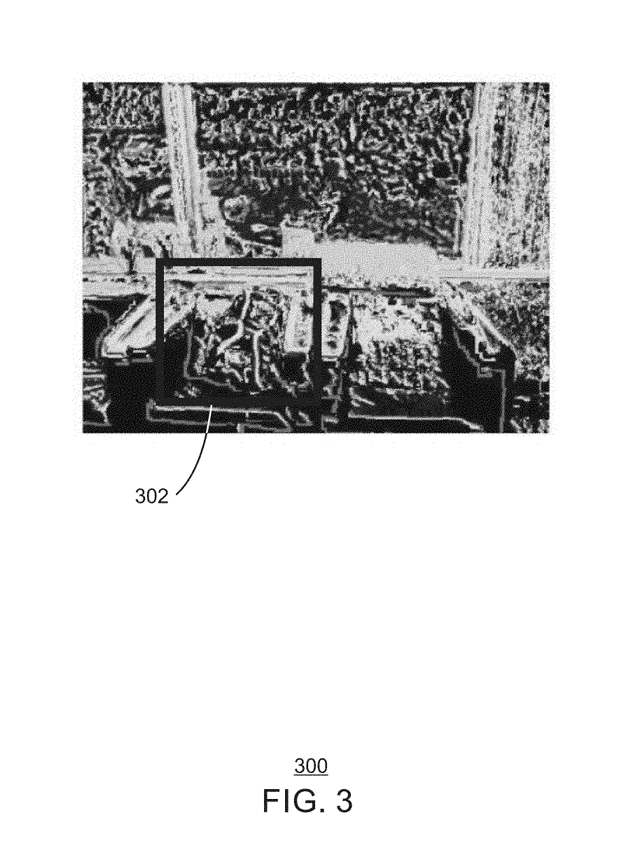

In the example of FIG. 2, one of the cameras 212, 214, 216, and 218 may be denoted as a reference camera, such as the camera 212. The disparity is estimated for each pixel in the corresponding reference image 202 by matching an image patch surrounding this pixel with every other image from the array. For example, a camera 212 that was used to capture image 202 may be a reference camera. An estimate of the disparity of pixel 220A in the image 202 may be found by matching the pixel 220A to an image patch 220B, 220C, and 220D respectively from every other image such as image 204, 206, and 208 from the array. As illustrated, the pixel 220 is located on a backpack 250 in each image. Setting different exposures for each camera results in varying appearance of image features across the camera array as shown in the plurality of images 202, 204, 206, and 208. Further, when the reference cameras suffers from saturation as shown in the image 202 in regions inside the room, disparity can be estimated accurately in these regions using the other camera images which have not saturated in these regions. Accordingly, image pairs that do not include the reference image 202, such as image 204/image 206, image 204/image 208, and image 206/image 208 can be used to estimate disparity. The present techniques utilize all camera pairs (and not just those involving the reference camera) and models saturation in an error function computed to estimate disparity more accurately as shown in FIG. 3.

FIG. 3 is an illustration of a disparity map 300. The disparity map 300 may be generated using disparity estimation as described herein. The results of the present techniques on the same set of input images from a 2×2 camera array 200 (FIG. 2) are illustrated in FIG. 3. Improvements are visible in the region 302 that includes the backpack 250 from FIG. 2. Thus, disparity estimates can be found even when even when a reference image is oversaturated or without any visual information. Using this disparity estimation, all images from the camera array can be warped to the reference image. The warped images can then be merged to create an HDR image or video.

For example, assume that the cameras are synchronized and geometric calibration (extrinsic and intrinsic) is available for all the cameras in the array. For ease of description, assume the camera array is planar and images are rectified such that conjugate epipolar lines are parallel to one of the image axes (horizontal or vertical). Denote the set of rectified images from a planar camera array using the following equation:

Iₖ(x, t)k≤N Eqn. 1

where Iₖ(x, t) represents the image from kth camera captured at time instant t. Here, x=(x, y) represents orthogonal axes in a 3D reference coordinate frame that are aligned with the columns and rows of the images respectively. No knowledge of camera response curves or exposure values assigned to each camera is assumed. The baseline of camera k is:

{Bₖ=[bₖ^{x}, bₖ^{y}], k≤N} Eqn. 2

while the baseline of the reference camera is B_{ref}=0 without any loss of generality. Without a loss of generality refers to not making any additional assumptions by setting B_{ref}=0. Any camera may be chosen as the reference and the baselines can be adjusted to ensure that B_{ref}=0. Let Bₘₐₓ represent the longest baseline (horizontal or vertical) in the array and let R_{K} represent the baseline ratio for camera k given by

$${R}_{k}^{x} = \frac{{R}_{k}^{x}}{{B}_{max}}$$

and a similar definition for Rky,

$${R}_{k}^{y} = \frac{{R}_{k}^{y}}{{B}_{max}}$$

Let d*(x, t) denote the estimated disparity map, where d* represents a best disparity map. Once the disparity map is estimated for the reference image, this can be used to warp each image from the camera array to the reference image. The resulting aligned images can them be merged to improve the dynamic range of the reference image. Let I_{ref}(x, t) denote the reference image and let d*(x, t) represent the corresponding disparity map, where t is a pixel in the image. Although warping can be performed on a per-pixel basis, this can result in artifacts due to the noisy disparity maps. In embodiments, warping is performed using overlapping windows to ameliorate the effects of noise in the disparity map. To warp each input image Iₖ(x,t) to the reference image, copy a window M surrounding each pixel in the input image to the warped image (initialized to zero) using the corresponding disparity value. The window M is a set that includes all windows m in the input image I. For ease of description, the windows m are described as extending a number of pixels below, above, to the right, and to the left of pixel x. In this manner, each window m forms a block surrounding the pixel k. However, the windows m may be of any size or shape.

A count C(x, t) may be calculated for each of the warped pixels (initialized to zero) so that the warped pixels can be normalized at the end of the warping operation. Consider the following equations:

Gₖ(x+m, t)=Gₖ(x+m, t)+Iₖ[x+d*(x)Bₖ+m, t], m ∈ M Eqn. 3

Cₖ(x+m, t)=Cₖ(x+m, t)+1, m ∈ M Eqn. 4

As shown in Eqn. 3, the warped image Gₖ(x+m, t) is found by adding the portion of the image Iₖ within the window m surrounding pixel x using the corresponding disparity value. Put another way, the disparity value is used to determine the effect that each window m has on the total warped image Gₖ(x+m, t). The count Cₖ(x+m, t) is increased by 1 for each pixel that is warped in the image I.

The warped image Hₖ(x, t) can then be generated as follows.

$${H}_{k} ( x , t ) = \frac{{G}_{k} ( x , t )}{{C}_{k} ( x , t )} \qquad Eqn . 5$$

Here, the initial warped image Gₖ(x+m, t) is normalized or averaged by for each pixel, dividing the total initial warped image Gₖ(x+m, t) by the count Cₖ(x+m, t).

In embodiments, to minimize artifacts that may occur due to misalignment while merging multiple images, the reference image is combined with just one of the other images at each pixel. The other image is chosen at each pixel location as the one that has the most high frequency content and does not suffer from saturation.

k*(x, t)=argmax_{k≠ref}|J|Hₖ(x,t)∥ if Hₖ(x, t)≥Tₘᵢₙ and Hₖ(x, t)≤Tₘₐₓ Eqn. 6

Thus, the image k* represents an image that has the highest frequency content at each pixel location, as the best, most high frequency content is used for each pixel location. For each pixel location, it is this best image that is used for merging the warped image with the reference image to improve dynamic range.

In Eqn. 6, J is a high pass filter. A linearly weighted sum at each pixel is used to merge the warped images with the reference image to improve its dynamic range. The weights at each pixel location are selected as a function of how well exposed the reference image is, where a is the weight as indicated in Eqn. 7. In embodiments, a Gaussian function is used to implement the weights whose mean is the midpoint of the intensity scale. Reference pixels near this mean are assigned the highest weights and the weights decrease for reference pixels closer to the endpoints, which are likely saturated. Eqn. 8 illustrates finding the merged pixel M(x, t).

$$\begin{matrix}α ( x , t ) = {e}^{- \frac{{[ {H}_{ref} ( x , t ] - μ )}^{2}}{2 * {σ}^{2}}} & Eqn . 7 \\ M ( x , t ) = α ( x , t ) {I}_{ref} ( x , t ) + [ 1 - α ( x ] {I}_{{k}^{*}} ( x , t ) & Eqn . 8\end{matrix}$$

The present techniques may be implemented in a multi-scale manner using a Gaussian pyramid. Utilizing a pyramidal decomposition enables seamless blending. Disparity estimation is performed at integer precision on the Gaussian pyramid using a coarse-to-fine approach, where the disparity map at each scale is upscaled and doubled in value for use as the midpoint of the search range at the next finer scale. Disparity estimation is performed on the input images at the finest scale.

At the coarsest scale, warping and merging are performed on the output of the Gaussian pyramid. At the remaining scales, warping and merging may be performed on a corresponding Laplacian pyramid. The resulting Laplacian pyramid is inverted to obtain the merged HDR image. Weights for merging were computed using the input images and the resulting weight map was decomposed using a Gaussian pyramid to obtain weights at each scale. Finally, choice of the best image to merge with can be made by simply comparing the magnitudes of the Laplacian pyramid coefficients which represents the high pass content of the image.

Additionally, in the Gaussian pyramid, subsequent images are weighted down using a Gaussian average or Gaussian blur, and then scaled down. Each pixel contains a local average that corresponds to a pixel neighborhood on a lower level of the pyramid. The image pyramid which can provide computational savings for large disparity search ranges. Disparity computed at the coarsest scale of the image pyramid can be up-sampled and doubled in value for use as the midpoint of the search range at the next scale. In embodiments, each image from each camera is decomposed into a Gaussian pyramid separately. Disparity is then computed between every component of the Gaussian pyramid in one camera image against the corresponding component from the other camera images using the same technique.

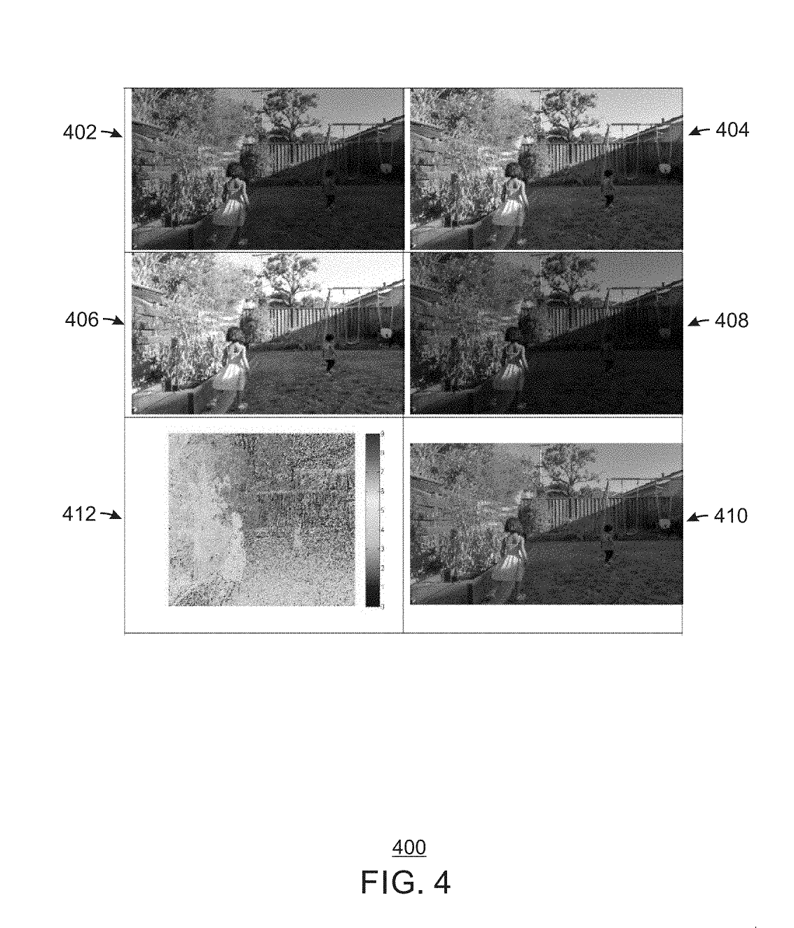

FIG. 4 is an illustration of images captured by a camera array and the resulting HDR image. In embodiments, images 402, 404, 406, and 408 were captured using an array of 4 cameras in a 2×2 square configuration with a baseline of 5 mm between adjacent cameras. The cameras may be geometrically calibrated and camera images were rectified. The merged image 410 is able to reproduce the dynamic range of the scene better that any individual camera of the array. The merged, high dynamic range image 410 also provides detail in both the dark and bright regions of the scene. Note that there are no visible artifacts in the merged image despite the noisy disparity map 412.

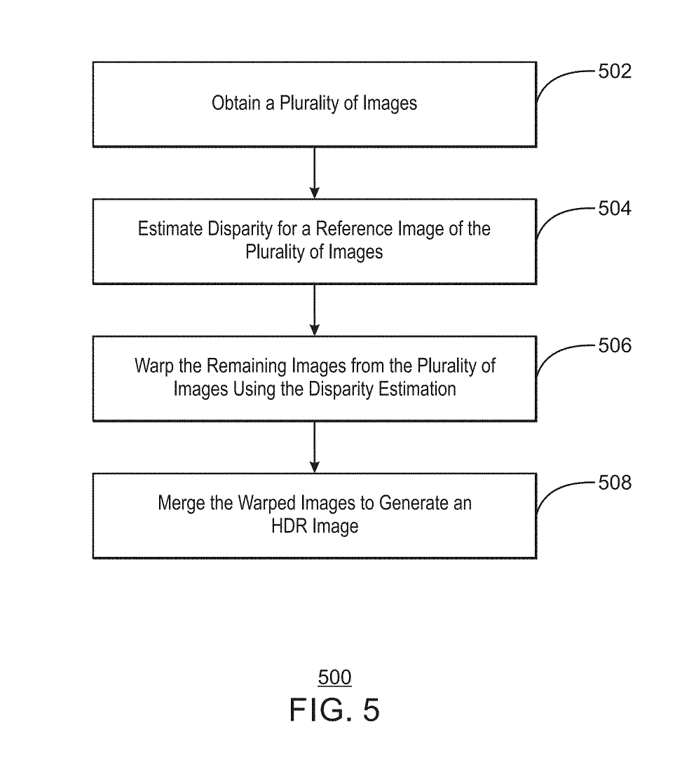

FIG. 5 is a process flow diagram of a method 500 for HDR imaging. At block 502, a plurality of images is obtained. The plurality of images may include multiple images of the same scene as captured by a plurality of cameras in a camera array. Intensity variations in the plurality of images may occur due to varying exposures assigned to individual cameras for high dynamic range (HDR) imaging or may result from a heterogeneity of the sensors in the camera array.

At block 504, disparity may be estimated for a reference image of the plurality of images. Any image of the plurality of images can be denoted as the reference image. To calculate the disparity map, the camera array may be in any position, such as planar, linear, and circular. A sequence of color matched images is generated from the plurality of images. In embodiments, the color matching may include matching color based on features in an image histogram. Color matching may also be performed via matching pixel values across two input images with a thresholded mapping function slope. A plurality of disparity points are calculated based on the sequence of color matched images. In embodiments, the plurality of disparity points is used to generate a disparity map. The plurality of disparity points may be calculated using an error function that is to determine a minimum at a correct matching disparity point between the sequence of color matched images. The error function may apply a weight to the sequence of color matched images to model saturation in each image, and the weight may use a binary function to avoid saturated pixels in the error function.

At block 506, the remaining images from the plurality of images are warped to the reference image using the disparity map. In embodiments, warping occurs by obtaining a window of pixel data surrounding a pixel and warping the window to the corresponding window in the reference image. The warping as described herein moves pixels within the window such that the resulting warped pixel appears from the same position as the reference image. The disparity estimation can be used to specify a location for each window in the final warped image. In particular, the warped image is found by adding the portion of the image within the window m surrounding a pixel X using the corresponding disparity value. The summed windows are then normalized.

At block 508, the warped images are merged to create an HDR image. During merging, the final image is obtained by selecting the highest frequency content pixel for each pixel location from the plurality of warped images. While the present techniques have been described by referring to an image, an HDR video may also be generated by applying the present techniques to each frame of a video.

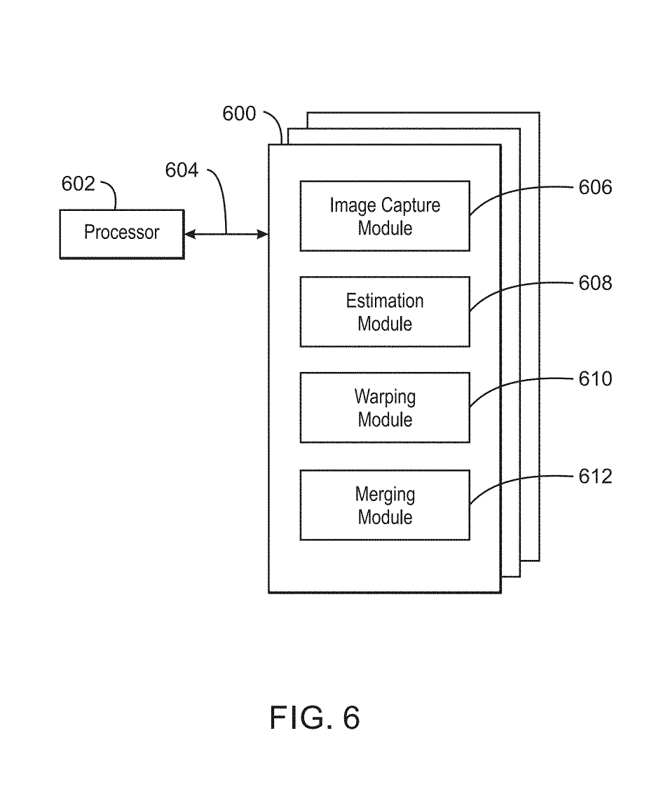

FIG. 6 is a block diagram showing media 600 that contains logic for HDR imaging via a camera array. The media 600 may be a computer-readable medium, including a non-transitory medium that stores code that can be accessed by a processor 602 over a computer bus 604. For example, the computer-readable media 600 can be volatile or non-volatile data storage device. The media 600 can also be a logic unit, such as an Application Specific Integrated Circuit (ASIC), a Field Programmable Gate Array (FPGA), or an arrangement of logic gates implemented in one or more integrated circuits, for example.

The media 600 may include modules 606-612 configured to perform the techniques described herein. For example, an image capture module 606 may be configured to capture a plurality of images. An estimation module 608 may be configured to estimate image disparity based on a sequence of color matched images. A warping module 610 may be configured to warp each image of the plurality of image to a reference image via the disparity estimation. A merging module 612 may merge each warped image to derive an HDR image. In some embodiments, the modules 606-612 may be modules of computer code configured to direct the operations of the processor 602.

The block diagram of FIG. 6 is not intended to indicate that the media 600 is to include all of the components shown in FIG. 6. Further, the media 600 may include any number of additional components not shown in FIG. 6, depending on the details of the specific implementation.

HDR imaging via camera arrays as described herein accounts for the disparity among images. Because of this, the present techniques can generate HDR images even with objects close to the camera. Moreover, the disparity estimation described herein is computationally efficient when compared to multi-step disparity estimation frameworks and the use of radiometric calibration. Further, the present techniques can generate HDR images from a camera array even when an image from the camera array suffers from significant saturation. Finally, the present techniques can produce an HDR image directly, without the use of tone mapping to produce resulting in a more computationally efficient calculation.

Example 1 is a system for high dynamic range (HDR) imaging for camera arrays. The system includes a camera array; a memory configured to store imaging data; and a processor coupled to the memory and the camera array, the processor to: obtain a plurality of images captured in a synchronized manner with different exposure times or gains; calculate a disparity estimation of a reference image of the plurality of images; warp a plurality of remaining images from the plurality of images to the reference image using the disparity estimation; and merge the plurality of warped remaining images and the reference image to obtain a high dynamic range image.

Example 2 includes the system of example 1, including or excluding optional features. In this example, the disparity estimation is generated by modeling a sensor saturation and utilizing camera pairs without saturation to determine the disparity estimation for a reference image.

Example 3 includes the system of any one of examples 1 to 2, including or excluding optional features. In this example, the disparity estimation comprises generating a sequence of color matched image pairs, wherein the sequence comprises each pair of images in the plurality of images. Optionally, a plurality of disparity points are calculated based on the sequence of color matched image pairs.

Example 4 includes the system of any one of examples 1 to 3, including or excluding optional features. In this example, warping the plurality of remaining images comprises, for each image, adding a portion of the image within a window surrounding a pixel to a window sum using the corresponding disparity value and normalizing the summed windows.

Example 5 includes the system of any one of examples 1 to 4, including or excluding optional features. In this example, warping comprises mapping each image of the remaining images to appear from a same position of the reference image.

Example 6 includes the system of any one of examples 1 to 5, including or excluding optional features. In this example, merging comprises selecting a highest frequency content pixel for each pixel location in the HDR image from the plurality of warped images and using a weighted combination of this pixel with the reference pixel.

Example 7 includes the system of any one of examples 1 to 6, including or excluding optional features. In this example, the disparity estimation is calculated at each scale of the output of a Gaussian pyramid.

Example 8 includes the system of any one of examples 1 to 7, including or excluding optional features. In this example, sensors of the camera array are heterogeneous.

Example 9 includes the system of any one of examples 1 to 8, including or excluding optional features. In this example, the camera array is a planar, linear, or circular array.

Example 10 is a method for high dynamic range (HDR) imaging for camera arrays. The method includes capturing a plurality of images; calculating a disparity estimation of a reference image of the plurality of images; warping a plurality of remaining images from the plurality of images to the reference image using the disparity estimation; and merging the plurality of warped remaining images and the reference image to obtain a high dynamic range image.

Example 11 includes the method of example 10, including or excluding optional features. In this example, the plurality of images are captured in a synchronized manner using different exposure times or gains.

Example 12 includes the method of any one of examples 10 to 11, including or excluding optional features. In this example, the plurality of images are captured via a plurality of cameras is a camera array, wherein the cameras comprise heterogeneous sensors that capture images with varying intensities.

Example 13 includes the method of any one of examples 10 to 12, including or excluding optional features. In this example, warping the plurality of remaining images is performed via a set of overlapping windows.

Example 14 includes the method of any one of examples 10 to 13, including or excluding optional features. In this example, merging the plurality of warped remaining images and the reference image comprises combining the reference image with single image at each pixel. Optionally, the single image is selected as the image with the highest frequency content for each respective pixel.

Example 15 includes the method of any one of examples 10 to 14, including or excluding optional features. In this example, the disparity estimation is generated by modeling a sensor saturation and selecting camera pairs without saturation to determine the disparity estimation for a reference image.

Example 16 includes the method of any one of examples 10 to 15, including or excluding optional features. In this example, the disparity estimation comprises generating a sequence of color matched images, wherein the sequence comprises each pair of images in the plurality of images.

Example 17 includes the method of any one of examples 10 to 16, including or excluding optional features. In this example, warping comprises mapping each image of the remaining image to appear from a same position of the reference image.

Example 18 includes the method of any one of examples 10 to 17, including or excluding optional features. In this example, the high dynamic range image provides detail in both the dark and bright regions of the image.

Example 19 is an apparatus for high dynamic range (HDR) imaging for camera arrays. The apparatus includes a camera array to obtain a plurality of images; a disparity unit to calculate a plurality of disparity points for a reference image based on a sequence of color matched image pairs; and a controller to warp a plurality of remaining images to the reference image using the disparity points and merge the plurality of warped images and the reference image to obtain a high dynamic range image.

Example 20 includes the apparatus of example 19, including or excluding optional features. In this example, the plurality of disparity points are generated by modeling a sensor saturation and utilizing camera pairs without saturation to determine the disparity estimation for a reference image.

Example 21 includes the apparatus of any one of examples 19 to 20, including or excluding optional features. In this example, the calculating the plurality of disparity points comprises generating a sequence of color matched image pairs, wherein the sequence comprises each pair of images in the plurality of images. Optionally, the plurality of disparity points are used to generate a disparity estimation.

Example 22 includes the apparatus of any one of examples 19 to 21, including or excluding optional features. In this example, warping the plurality of remaining images comprises, for each image, adding a portion of the image within a window surrounding a pixel to a window sum using the corresponding disparity value and normalizing the summed windows.

Example 23 includes the apparatus of any one of examples 19 to 22, including or excluding optional features. In this example, warping the plurality of remaining images comprises mapping each image of the remaining images to appear from a same position of the reference image.

Example 24 includes the apparatus of any one of examples 19 to 23, including or excluding optional features. In this example, merging the plurality of warped images comprises selecting a highest frequency content pixel for each pixel location in the HDR image from the plurality of warped images and using a weighted combination of this pixel with the reference pixel.

Example 25 includes the apparatus of any one of examples 19 to 24, including or excluding optional features. In this example, the plurality of disparity points are calculated at each scale of the output of a Gaussian pyramid.

Example 26 includes the apparatus of any one of examples 19 to 25, including or excluding optional features. In this example, the camera array comprises a plurality of heterogeneous sensors that capture the plurality of images with varying intensities.

Example 27 includes the apparatus of any one of examples 19 to 26, including or excluding optional features. In this example, the camera array is a planar, linear, or circular array.

Example 28 is a tangible, non-transitory, computer-readable medium. The computer-readable medium includes instructions that direct the processor to capture a plurality of images; calculate a disparity estimation of a reference image of the plurality of images; warp a plurality of remaining images from the plurality of images to the reference image using the disparity estimation; and merge the plurality of warped remaining images and the reference image to obtain a high dynamic range image.

Example 29 includes the computer-readable medium of example 28, including or excluding optional features. In this example, the plurality of images are captured in a synchronized manner using different exposure times or gains.

Example 30 includes the computer-readable medium of any one of examples 28 to 29, including or excluding optional features. In this example, the plurality of images are captured via a plurality of cameras is a camera array, wherein the cameras comprise heterogeneous sensors that capture images with varying intensities.

Example 31 includes the computer-readable medium of any one of examples 28 to 30, including or excluding optional features. In this example, warping the plurality of remaining images is performed via a set of overlapping windows.

Example 32 includes the computer-readable medium of any one of examples 28 to 31, including or excluding optional features. In this example, merging the plurality of warped remaining images and the reference image comprises combining the reference image with single image at each pixel. Optionally, the single image is selected as the image with the highest frequency content for each respective pixel.

Example 33 includes the computer-readable medium of any one of examples 28 to 32, including or excluding optional features. In this example, the disparity estimation is generated by modeling a sensor saturation and selecting camera pairs without saturation to determine the disparity estimation for a reference image.

Example 34 includes the computer-readable medium of any one of examples 28 to 33, including or excluding optional features. In this example, the disparity estimation comprises generating a sequence of color matched images, wherein the sequence comprises each pair of images in the plurality of images.

Example 35 includes the computer-readable medium of any one of examples 28 to 34, including or excluding optional features. In this example, warping comprises mapping each image of the remaining image to appear from a same position of the reference image.

Example 36 includes the computer-readable medium of any one of examples 28 to 35, including or excluding optional features. In this example, the high dynamic range image provides detail in both the dark and bright regions of the image.

Example 37 is an apparatus for high dynamic range (HDR) imaging for camera arrays. The apparatus includes instructions that direct the processor to a camera array to obtain a plurality of images; a means to calculate a plurality of disparity points for a reference image based on a sequence of color matched image pairs; and a means to warp a plurality of remaining images to the reference image using the disparity points and merge the plurality of warped images and the reference image to obtain a high dynamic range image.

Example 38 includes the apparatus of example 37, including or excluding optional features. In this example, the plurality of disparity points are generated by modeling a sensor saturation and utilizing camera pairs without saturation to determine the disparity estimation for a reference image.

Example 39 includes the apparatus of any one of examples 37 to 38, including or excluding optional features. In this example, the calculating the plurality of disparity points comprises generating a sequence of color matched image pairs, wherein the sequence comprises each pair of images in the plurality of images. Optionally, the plurality of disparity points are used to generate a disparity estimation.

Example 40 includes the apparatus of any one of examples 37 to 39, including or excluding optional features. In this example, warping the plurality of remaining images comprises, for each image, adding a portion of the image within a window surrounding a pixel to a window sum using the corresponding disparity value and normalizing the summed windows.

Example 41 includes the apparatus of any one of examples 37 to 40, including or excluding optional features. In this example, warping the plurality of remaining images comprises mapping each image of the remaining images to appear from a same position of the reference image.

Example 42 includes the apparatus of any one of examples 37 to 41, including or excluding optional features. In this example, merging the plurality of warped images comprises selecting a highest frequency content pixel for each pixel location in the HDR image from the plurality of warped images and using a weighted combination of this pixel with the reference pixel.

Example 43 includes the apparatus of any one of examples 37 to 42, including or excluding optional features. In this example, the plurality of disparity points are calculated at each scale of the output of a Gaussian pyramid.

Example 44 includes the apparatus of any one of examples 37 to 43, including or excluding optional features. In this example, the camera array comprises a plurality of heterogeneous sensors that capture the plurality of images with varying intensities.

Example 45 includes the apparatus of any one of examples 37 to 44, including or excluding optional features. In this example, the camera array is a planar, linear, or circular array.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system for high dynamic range (HDR) imaging for camera arrays, comprising:
a camera array;
a memory configured to store imaging data; and
a processor coupled to the memory and the camera array, the processor to:
obtain a plurality of images captured in a synchronized manner with different exposure times or gains;
calculate a disparity estimation of a reference image of the plurality of images;
warp a plurality of remaining images from the plurality of images to the reference image using the disparity estimation; and
merge the plurality of warped remaining images and the reference image to obtain a high dynamic range image.

2. The system of claim 1, wherein the disparity estimation is generated by modeling a sensor saturation and utilizing camera pairs without saturation to determine the disparity estimation for a reference image.

3. The system of claim 1, wherein the disparity estimation comprises generating a sequence of color matched image pairs, wherein the sequence comprises each pair of images in the plurality of images.

4. The system of claim 1, wherein the disparity estimation comprises generating a sequence of color matched image pairs, wherein the sequence comprises each pair of images in the plurality of images and a plurality of disparity points are calculated based on the sequence of color matched image pairs.

5. The system of claim 1, wherein warping the plurality of remaining images comprises, for each image, adding a portion of the image within a window surrounding a pixel to a window sum using the corresponding disparity value and normalizing the summed windows.

6. The system of claim 1, wherein warping comprises mapping each image of the remaining images to appear from a same position of the reference image.

7. The system of claim 1, wherein merging comprises selecting a highest frequency content pixel for each pixel location in the HDR image from the plurality of warped images and using a weighted combination of this pixel with the reference pixel.

8. The system of claim 1, wherein the disparity estimation is calculated at each scale of the output of a Gaussian pyramid.

9. The system of claim 1, wherein sensors of the camera array are heterogeneous.

10. The system of claim 1, wherein the camera array is a planar, linear, or circular array.

11. A method for high dynamic range (HDR) imaging for camera arrays, comprising, comprising:
capturing a plurality of images;
calculating a disparity estimation of a reference image of the plurality of images;
warping a plurality of remaining images from the plurality of images to the reference image using the disparity estimation; and
merging the plurality of warped remaining images and the reference image to obtain a high dynamic range image.

12. The method of claim 11, wherein the plurality of images are captured in a synchronized manner using different exposure times or gains.

13. The method of claim 11, wherein the plurality of images are captured via a plurality of cameras is a camera array, wherein the cameras comprise heterogeneous sensors that capture images with varying intensities.

14. The method of claim 11, wherein warping the plurality of remaining images is performed via a set of overlapping windows.

15. The method of claim 11, wherein merging the plurality of warped remaining images and the reference image comprises combining the reference image with single image at each pixel.

16. An apparatus for high dynamic range (HDR) imaging for camera arrays, comprising:
a camera array to obtain a plurality of images;
a disparity unit to calculate a plurality of disparity points for a reference image based on a sequence of color matched image pairs; and
a controller to warp a plurality of remaining images to the reference image using the disparity points and merge the plurality of warped images and the reference image to obtain a high dynamic range image.

17. The apparatus of claim 16, wherein the plurality of disparity points are generated by modeling a sensor saturation and utilizing camera pairs without saturation to determine the disparity estimation for a reference image.

18. The apparatus of claim 16, wherein the calculating the plurality of disparity points comprises generating a sequence of color matched image pairs, wherein the sequence comprises each pair of images in the plurality of images.

19. The apparatus of claim 16, wherein the calculating the plurality of disparity points comprises generating a sequence of color matched image pairs, wherein the sequence comprises each pair of images in the plurality of images and the plurality of disparity points are used to generate a disparity estimation.

20. The apparatus of claim 16, wherein warping the plurality of remaining images comprises, for each image, adding a portion of the image within a window surrounding a pixel to a window sum using the corresponding disparity value and normalizing the summed windows.

21. The apparatus of claim 16, wherein warping the plurality of remaining images comprises mapping each image of the remaining images to appear from a same position of the reference image.

22. A tangible, non-transitory, computer-readable medium comprising instructions that, when executed by a processor, direct the processor to:
capture a plurality of images;
calculate a disparity estimation of a reference image of the plurality of images;
warp a plurality of remaining images from the plurality of images to the reference image using the disparity estimation; and
merge the plurality of warped remaining images and the reference image to obtain a high dynamic range image.

23. The computer-readable medium of claim 22, wherein the disparity estimation is generated by modeling a sensor saturation and selecting camera pairs without saturation to determine the disparity estimation for a reference image.

24. The computer-readable medium of claim 22, wherein the disparity estimation comprises generating a sequence of color matched images, wherein the sequence comprises each pair of images in the plurality of images.

25. The computer-readable medium of claim 22, wherein warping comprises mapping each image of the remaining image to appear from a same position of the reference image.
